(19) United States
(12) Patent Application Publication
(10) Pub. No.: US 2005/0151876 A1
(43) Pub. Date: Jul. 14, 2005

(54) Multiple use permanently sealed digital camera

(76) Inventor: Sarah Rose Karr, Sarasota, FL (US)

Correspondence Address: Sarah Rose Karr, 445 15th Street, Santa Monica, CA, 90402, US

(21) Appl. No.: 10/877,841

(22) Filed: Jun. 26, 2004

Related U.S. Application Data
(60) Provisional application No. 60/534,768, filed on Jan. 8, 2004.

(51) Int. Cl. H04N 5/225; G03B 17/08; H04N 5/232; H02J 7/00

(52) U.S. Cl. 348/373; 348/211.2; 348/372; 320/107

(57) ABSTRACT

A permanently sealed digital camera is disclosed for use in harsh environment photography. The camera is permanently sealed in a hermetic housing/casing. The camera is charged and information is transmitted to and from the camera without the use of physical connectors. The camera includes an internal digital camera mechanism. The camera wirelessly receives energy from a base station and stores it in batteries. The camera communicates with said base station (for transmittal of photos, user settings, etc). The base station charges and communicates with the camera through wireless means (including, but not limited to optical and inductive charging and optical, inductive, capacitive, and radio communication).

### SUMMARY OF THE INVENTION

The present invention is directed to a novel and unique camera for use in harsh environments. The camera could be used in any benign or harsh environment including (but not limited to) sandy, dirty, muddy, corrosive or erosive, wet, low-pressure or high pressure, cold or hot environments, including but not limited to vacuum and underwater.

The invention includes a digital camera with a permanently sealed housing/casing. The housing could be filled with air or an inert gas such as nitrogen. There will be a few openings in the housing where permanent transparent windows will be located. These windows could be made of plastic, glass, sapphire, or any other transparent material. One window would be located in front of the lens of the camera, allowing photography. Another window might be located in the back or top of the camera housing allowing for either a traditional viewfinder window or an LCD monitor with which to preview photos. The controls for the camera could be operated in any manner that did not require the opening of the case, including but not limited to optical controls (motion, color sensors, light emitting and or reflecting, etc.) that would operate through small windows in the case (optical control), or through the use of a reed switch or other device relying on a magnetic field control. These controls could control many actions, including but not limited to taking photographs, zooming in and out, focusing, turning the camera on and off, and turning the flash on and off. Focus could be automatic or manual (to be manipulated by aforementioned controls). The preferred embodiment would have at least two windows: one for the lens and one for view finding. Either one of these windows could be used to receive power and transmit information to and from the base station (with a solid state light source and receiver placed behind the window). The camera could be built with magnetic, optical, or numerous other types of controls. For optical control, either another window or one of the existing windows could be used. Other types of controls (such as magnetic controls possibly using a Reed device(s) or Hall sensor(s)) would not require the use of a window.

The camera would be fitted with permanent internal rechargeable batteries (preferably Lithium Ion batteries) which would be charged using the device described in U.S. Pat. No. 6,707,274, “Optical Battery Recharger” (see prior art section). This “Optical Battery Charger” could also be used to receive and transmit information to and from the camera such as photos taken and user preferences and settings and could be connected to a computer, printer, base station, or other type of device. In this way, the camera could perform all of its essential functions without having its hermetic enclosure opened.

A matching cradle/charging station would exist for each camera. This cradle would match a small window (or windows) in the camera with a small window (or windows) in the base station. The camera and the base station should have the ability to send and receive information through an optical device (as described in U.S. Pat. No. 6,707,274, “Optical Battery Recharger” issued on Mar. 16^{th}, 2004 to Lawrence J. Karr). The camera and base station would communicate through the use of this optical device, and the base station's light source (as described in U.S. Pat. No. 6,707,274, “Optical Battery Recharger”) would provide charge to the camera when the camera was properly placed with respect to the base station. All safety precautions would be set up as described in the U.S. Pat. No. 6,707,274, “Optical Battery Recharger”, issued on Mar. 16^{th}, 2004 to Lawrence J. Karr.

The base station could charge and communicate with the camera through methods other than those described in U.S. Pat. No. 6,707,274, “Optical Battery Recharger”, such as through inductive charging and optical or radio communication.

### DETAILED DESCRIPTION OF THE PREFERRED EMBODIMENTS

In the following section, specific embodiments of the invention will be described; however, they are only samples and should not be seen as the only possible embodiments of the invention.

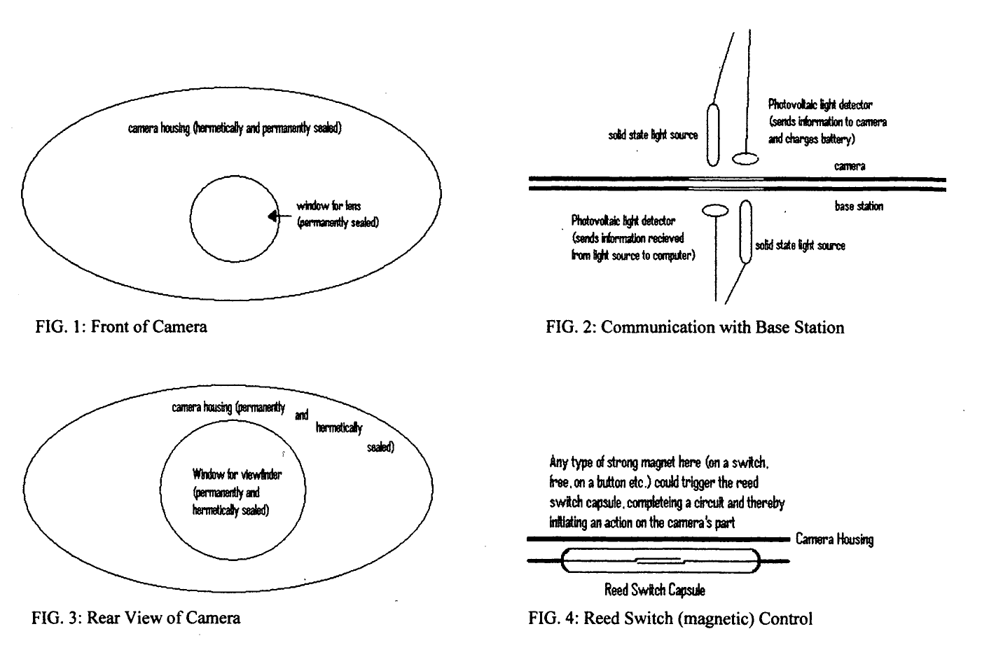

There are several main parts to the present invention: the camera machinery itself, the permanent housing of the camera (and, when applicable, attached magnetic switches) (FIGS. 1 and 3), the optical devices both inside and exterior to the camera to be used both in charging the camera and in communication between the camera and the base station or computer (FIG. 2), an internal rechargeable battery to be permanently sealed inside the camera (and recharged by an external solid state light source), and some means of control of the camera (including but not limited to optical, pressure sensing, magnetic, and temperature sensing control).

The base station will be constructed such that the camera's communication and charging window(s) is aligned with the window on the base station (FIG. 2). The base station will be set up as described in U.S. Pat. No. 6,707,274, “Optical Battery Recharger”, issued on Mar. 16^{th}, 2004 to Lawrence J. Karr.

The camera will be able to capture and store still or moving pictures in a digital format through the use of a lens, optical sensor, image processing means, and a memory/storage device. It could include a display with which to review past pictures and to use as a viewfinder, a zoom function, read out of what mode the camera is in, how much space is left in the memory or numerous other functions. The camera will not have removable memory (as most digital cameras do). The memory device on which the pictures will be stored will be permanently sealed in the camera. The memory will be accessible through the serial interface provided between the camera and the base station, in accordance with U.S. Pat. No. 6,707,274 “Optical Battery Recharger”. The camera will be configured to be controlled without opening or distorting the casing (no depressible buttons that could leak). The camera will have an optical means of sending information to the base station (as described in U.S. Pat. No. 6,707,274, “Optical Battery Recharger”). It will be able to receive information from the base station via optical means (generally via the base station's solid state light source). It will also have a means of storing energy, from the base station's solid state light source, in its internal rechargeable battery.

The case/housing of the camera will be constructed of sturdy corrosion-resistant material (possibly titanium) and will contain a window (made of glass, sapphire or other transparent material) to admit light to the camera's lens. In its preferred form, it may also carry at least one other window to serve either as a traditional viewfinder or as a digital viewfinder (a larger window in front of an LCD or other type of screen which could project both the photo about to be taken and review past photos). The camera may also include windows for optical controls. If magnetic controls are used, more windows will not be necessary, as magnets will trigger various actions on the camera's part, without penetrating the case (using a reed switch or other type of device, FIG. 4). The casing must include a window for optically communicating with the base station and for receiving charge optically (via a solid state light source) from the base station; however, this window could also be the one used for view finding or taking pictures.

1. A camera for electronic digital photography with a permanently, hermetically sealed housing, comprising:
a. An internal unit incorporating a digital camera mechanism to capture and store still or moving photographs.
b. A permanently sealed casing with permanently sealed windows for the capturing of photos, displaying of photos (or view finding) and possibly for control of the camera.
c. A unit inside the device to wirelessly receive power from a base station without physical connectors and store the energy in the batteries, and to receive information from the base station.

2. The device in accordance with claim 1, wherein a unit inside of the device transmits information from the device to the base station via a solid state light source (U.S. Pat. No. 6,707,274, “Optical Battery Recharger” issued on Mar. 16^{th}, 2004 to Lawrence J. Karr).

3. The device in accordance with claim 1, wherein a base station is set up with a cradle to align the camera with the base station and to supply power to the device.

4. The device in accordance with claim 1, wherein the base station receives communication from the camera.

5. The device in accordance with claim 1, wherein the base station sends information to the camera.

6. The device in accordance with claim 1, wherein one or all of the light sources for communication and energy transfer between the base station and the device is(are) a laser diode.

7. The device in accordance with claim 1, wherein one or all of the light sources for communication and energy transfer between the base station and device is an LED.

8. The device in accordance with claim 1 when controls are operated via color, light, magnetic field, pressure, movement sensors, or any other means that do not require the opening of the camera.

9. The device in accordance with claim 1 when the device has a traditional viewfinder.

10. The device in accordance with claim 1 when the device has a digital display viewfinder.

11. The device in accordance with claim 1, wherein the housing of the camera is constructed of permanently sealed non-metallic material.

12. The device in accordance with claim 1, wherein the housing of the camera is made of metal.

13. The device in accordance with claim 1, wherein the safety device described in U.S. Pat. No. 6,707,274, “Optical Battery Recharger” issued on Mar. 16^{th}, 2004 to Lawrence J. Karr is included in the device to keep the base and or camera from emitting light from the communicator/charger when the camera and base station are not properly aligned.

14. The device in accordance with claim 1, wherein an inert gas fills the inside of the camera.

15. The device in accordance with claim 1, wherein air fills the inside of the camera.

16. The device in accordance with claim 1, the inside of the camera is a vacuum.

17. The device in accordance with claim 1, wherein said base station has the capability to print photos or to communicate with other devices (such as a computer) for viewing and possible printing of said photos.

18. The device in accordance with claim 1, wherein said device's controls are operated with the use of magnets or magnetically controlled switches (such as a reed switch or capsule (see FIG. 4).

19. The device in accordance with claim 1, wherein there is no viewfinder on the device.

20. The device in accordance with claim 1, wherein inductive charging, rather than optical means, is used to charge the camera (generally via a base station).

21. The device in accordance with claim 1, wherein inductive, capacitive, and or radio signals are used for communication between the camera and computer or base station (rather than or in conjunction with optical means).
